(19) United States
(12) Patent Application Publication
(10) Pub. No.: US 2015/0198206 A1
(43) Pub. Date: Jul. 16, 2015

(54) TORQUE-TRANSMITTING JOINT AND JOINT COMPONENTS, METHODS OF MANUFACTURING, AND METHODS OF INSPECTION

(71) Applicant: Nexteer (Beijing) Technology Co., Ltd., Saginaw, MI (US)

(72) Inventors: Steven M. Thomas, Saginaw, MI (US); William P. Skvarla, Saginaw, MI (US); Eduardo R. Mondragon-Parra, Freeland, MI (US)

(21) Appl. No.: 14/540,734

(22) Filed: Nov. 13, 2014

Related U.S. Application Data
(60) Provisional application No. 61/903,870, filed on Nov. 13, 2013.

(51) Int. Cl. F16D 3/205

(52) U.S. Cl. CPC F16D 3/205; F16D 2003/2026

(57) ABSTRACT

A component of a torque-transmitting joint is provided that includes bearing surfaces that engage adjacent components, wherein the bearing surfaces of the plurality of trunnions define unique surface texturing and lubrication. Additional configurations of the torque-transmitting joint, methods of manufacture, and methods of dimensional inspection are also provided by the present disclosure. As a result, break-in time and generated axial force (GAF) of the torque-transmitting joint are significantly reduced.

### CROSS-REFERENCE TO RELATED APPLICATIONS

This patent application claims priority to U.S. Provisional Patent Application Ser. No. 61/903,870, filed Nov. 13, 2013, which is incorporated herein by reference in its entirety.

### FIELD

The present disclosure relates to mechanical joints, and more specifically to torque-transmitting joints for use in vehicle driveshafts.

### BACKGROUND

The statements in this section merely provide background information related to the present disclosure and may not constitute prior art.

Torque-transmitting joints are generally used in vehicle driveshafts, especially in front-wheel-drive vehicles, and allow a drive shaft to transmit power through a variable angle, at constant rotational speed. In operation, the torque-transmitting joint transmits torque at various speeds, angles and telescopic positions, and also operates to prevent or reduce vibrations through the joint. The component parts of such a joint, such as trunnions of a spider and mating roller assemblies, undergo a significant amount of friction and axial forces as the vehicle is exposed to a variety of driving conditions.

In order to reduce friction, various lubricants may be employed between the mating surfaces of joint components. A factory-new joint typically has a “break-in” period, in which the surfaces that undergo friction wear against each other and establish a wear pattern, and mating surfaces of joint components are geometrically altered from their nominal condition. The break-in period can vary from several hundred miles to thousands of miles, depending on initial conditions of the mating components and driving habits of the customer. Original Equipment Manufacturers (OEMS) are continuing to place new and more stringent requirements on their parts suppliers, which include reducing or even eliminating the break-in period, and increasing the durability of many vehicle components, including constant velocity joints.

### SUMMARY

In one form of the present disclosure, a component of a torque-transmitting joint is provided that comprises a body defining an outer profile and a central bore, and a plurality of trunnions disposed around the outer profile of the body, each of the plurality of trunnions defining bearing surfaces that engage adjacent components of corresponding roller assemblies that engage with the plurality of trunnions in operation. The bearing surfaces of the plurality of trunnions define a surface texturing having a random particulate layout of pits having a length/width aspect ratio between about 1:1 and about 5:1, a roughness skewness (Rₛₖ) between about −3.5 and about −0.6, a roughness kurtosis (Rₖᵤ) greater than about 3, and a root mean square roughness (R_{q}) is greater than a root mean square roughness (R_{q}) of mating surfaces of the adjacent components.

In another form of the present disclosure, a torque-transmitting joint is provided that comprises a housing, an inner drive member disposed within the housing, and a spider assembly secured to a distal end portion of the inner drive member. The spider assembly comprises a spider body defining an outer profile and a central bore, a plurality of trunnions disposed around the outer profile of the spider body, a plurality of roller assemblies secured to the plurality of trunnions, each roller assembly comprising an outer ball, an inner ball, and a plurality of roller bearings disposed between the outer ball and the inner ball. Each of the plurality of trunnions defines bearing surfaces that engage the inner balls of corresponding roller assemblies, and the bearing surfaces of the plurality of trunnions define a surface texturing having a random particulate layout of pits having a length/width aspect ratio between about 1:1 and about 5:1, a roughness skewness (Rₛₖ) between about −3.5 and about −0.6, a roughness kurtosis (Rₖᵤ) greater than about 3, and a root mean square roughness (R_{q}) having a magnitude equal to a root mean square roughness (R_{q}) of mating surfaces of the adjacent components.

In still another form of the present disclosure, a component of a torque-transmitting joint is provided that comprises bearing surfaces having a surface texturing with a random particulate layout of pits having a length/width aspect ratio between about 1:1 and about 5:1, a roughness skewness (Rₛₖ) between about −3.5 and about −0.6, a roughness kurtosis (Rₖᵤ) greater than about 3, and a root mean square roughness (R_{q}) having a magnitude equal to a root mean square roughness (R_{q}) of mating surfaces of the adjacent components.

In another form, a torque-transmitting joint is provided that comprises a housing defining an internal Ball Circle Diameter (BCD) and a spider assembly disposed within the housing, the spider assembly comprising a spider body having a plurality of trunnions disposed around an outer profile of the spider body, each of the trunnions defining a center, through which a spider Ball Circle Diameter (BCD) is defined. The spider BCD is less than the housing internal BCD.

In yet another form, a housing for a torque-transmitting joint is provided that comprises a plurality of longitudinal bores and a central longitudinal axis, the plurality of longitudinal bores each defining a ball bore center through which passes a bore Ball Circle Diameter (BCD), and the housing defining an internal Ball Circle Diameter (BCD) having a BCD center. A variation of a radial position of the BCDs to the BCD center is less than a tangential or angular position variation of the ball bore BCDs.

Additionally, an internal component for a torque-transmitting joint is provided, the torque-transmitting joint having a housing in which the internal component is disposed, the internal component comprising a body defining an outer profile and a plurality of trunnions disposed around the outer profile of the body, each of the trunnions defining a geometric center. The body defines a Ball Circle Diameter (BCD) having a center, and a radial variation of the trunnion geometric centers to the BCD center is less than an angular position variation of the trunnion geometric centers at the BCD.

According to a method of the present disclosure, dimensional characteristics of a trunnion profile of a spider for use in a torque-transmitting joint are inspected, the method comprising calculating a trunnion center based on a nominal torus geometry, and calculating a Ball Circle Diameter (BCD) of the spider based on the trunnion center.

A method of fabricating a spider for use in a torque-transmitting joint is also provided, the spider comprising a plurality of trunnions, each trunnion defining bearing surfaces that engage adjacent components of corresponding roller assemblies that are secured to the plurality of trunnions, the method comprising performing a polishing operation on the bearing surfaces of the spider, wherein an average roughness (Ra) of the bearing surfaces divided by a five-point mean roughness (Rz) of the bearing surfaces is between about 0.05 and about 0.19.

Further yet, an inner ball for use in a roller assembly of a torque-transmitting joint is provided, the inner ball defining a concave inner surface nominally defined by a roughness profile and a waviness profile.

Also, an outer ball for use in a roller assembly of a torque-transmitting joint is provided, the outer ball defining an outer corner profile that contacts an internal corner surface of a housing in which the roller assembly traverses, wherein the outer corner profile defines a surface selected from the group consisting of an arc, an ellipse, a B-spline, a plurality of intersecting line segments, and combinations thereof, and a minimum dimension of the profile is about 2 mm.

In another form, a torque-transmitting joint is provided that comprises a housing having a plurality of longitudinal bores defining internal corner surfaces, an inner drive member disposed within the housing, a spider assembly secured to a distal end portion of the inner drive member, wherein the spider assembly comprises a spider body defining an outer profile and a central bore, the inner member being secured through the central bore, a plurality of trunnions disposed around the outer profile of the spider body, and a plurality of roller assemblies secured to the plurality of trunnions, each roller assembly comprising an outer ball, an inner ball, and a plurality of roller bearings disposed between the outer ball and the inner ball. The outer balls define a minimum dimension of about 2 mm proximate the internal surfaces of the housing along which the outer balls make contact.

These and other advantages and features will become more apparent from the following description taken in conjunction with the drawings.

### DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view, partially cut-away, illustrating a torque-transmitting joint constructed in accordance with the teachings of the present disclosure;

FIG. 2 is another perspective view, partially cut-away, illustrating the torque-transmitting joint with an inner member angled with respect to an outer housing and constructed and assembled in accordance with the teachings of the present disclosure;

FIG. 3 is a perspective view of a spider assembly and associated roller assemblies constructed in accordance with the principles of the present disclosure;

FIG. 4A is a perspective view of a spider body constructed in accordance with the principles of the present disclosure;

FIG. 4B is an enlarged perspective view of the spider body of FIG. 4a, illustrating bearing surfaces having an advantageous surface texturing in accordance with the principles of the present disclosure;

FIG. 5A is a photomicrograph of one form of the surface texturing according to the teachings of the present disclosure, with the surface texturing having a higher roughness skewness (Rsk);

FIG. 5B is a photomicrograph of one form of the surface texturing according to the teachings of the present disclosure, with the surface texturing having a lower roughness skewness (Rsk);

FIG. 6 is a cross-sectional view illustrating bearing surfaces of a spider assembly and constructed in accordance with the principles of the present disclosure;

FIGS. 7A-C are side views of a housing (FIG. 7A), a spider (FIG. 7B), and the spider assembled into the housing (FIG. 7C), in accordance with specific ball circle diameter (BCD) specifications of the present disclosure;

FIG. 8A is a side, cross-sectional view, illustrating a tolerancing scheme for the BCDs of a housing and spider trunnions in accordance with the teachings of the present disclosure;

FIG. 8B is a schematic illustration of the permitted radial variation of trunnion geometric centers and lateral or tangential variation of the ball bore centers in the housing of FIG. 8A.

FIG. 9A includes a perspective view of an inner ball;

FIG. 9B includes a dimensional view and schematic view illustrating both a roughness profile requirement and a waviness profile requirement of region B of FIG. 9A in accordance with specifications of the present disclosure;

FIG. 10A is a cross-sectional view illustrating geometric configurations for an outer ball of a roller assembly and its contact with internal portions of a housing in accordance with the teachings of the present disclosure;

FIG. 10B is a cross section of the roller assembly of FIG. 10A taken along Section X-X illustrating a tilted position on the left and a nominal (untitled) position on the right;

FIG. 11 is a perspective view of an embodiment of a housing illustrating areas of the housing that are contacted by the outer surface of the outer ball; and

FIG. 12 is a comparative plot of generated axial force as a function of joint angle between a torque-transmitting joint constructed in accordance with the teachings of the present disclosure and a joint of substantially similar construction that was not constructed in accordance with the teachings of the present disclosure.

### DETAILED DESCRIPTION

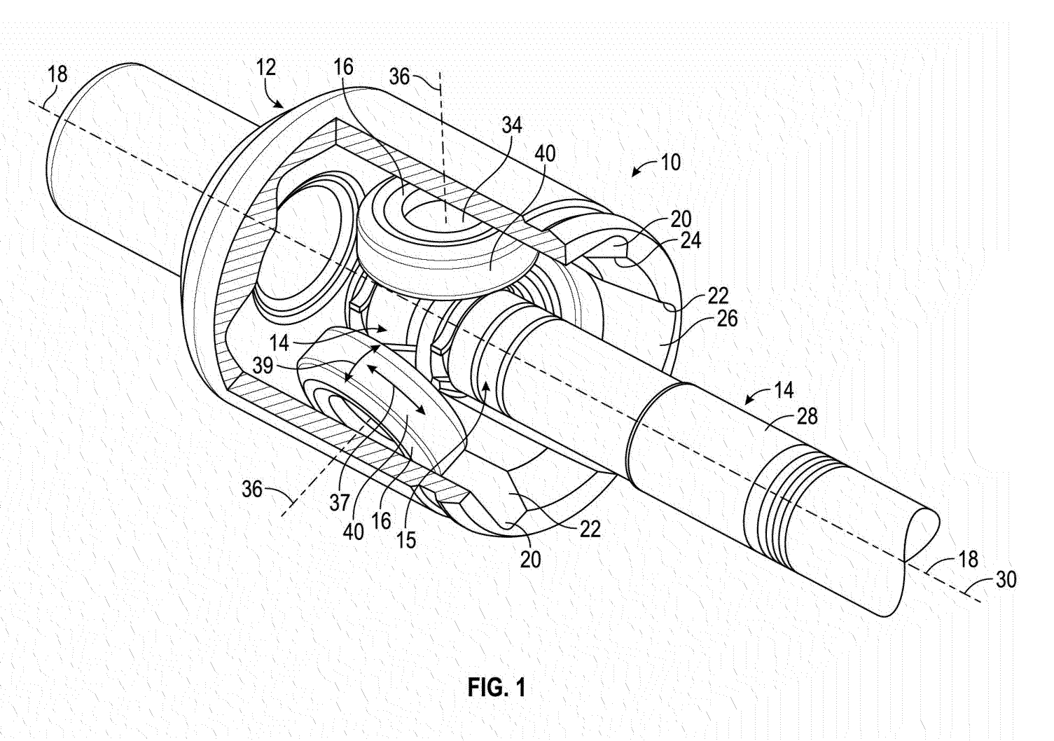

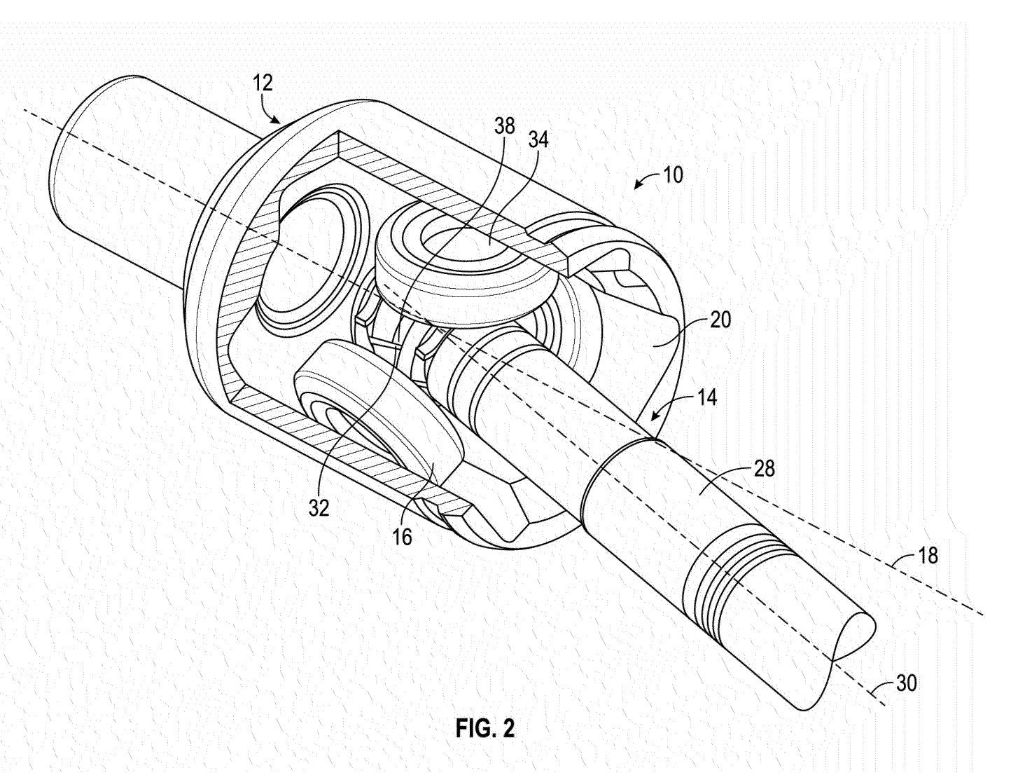

Referring now to the Figures, where the invention will be described with reference to specific embodiments, without limiting same, and more particularly referring to FIGS. 1 and 2, a torque-transmitting joint 10 includes a housing 12, an inner drive member 14 having a distal end portion 15, and three drive roller assemblies 16. In one form, the housing 12 has a longitudinal axis 18 about which it rotates and three longitudinal bores 20 which are equally spaced at substantially 120 degrees from each other and parallel to the axis 18. Each of the longitudinal bores 20 has two opposing internal corner surfaces 22, 24 separated circumferentially by a side wall 26, which faces radially inward in one form of the present disclosure. The inner drive member 14 has a shaft 28 and a longitudinal axis 30 about which the shaft 28 rotates. The longitudinal axes 18 and 30 coincide or are co-linear when the torque-transmitting joint 10 is at zero angle, as shown in FIG. 1, and intersect at a point on the longitudinal axis 18 when the torque-transmitting joint 10 is articulated or bent at an angle as shown in FIG. 2. The axes 18 and 30 intersect at a point on the longitudinal axis 18 which is spaced from a joint center 32.

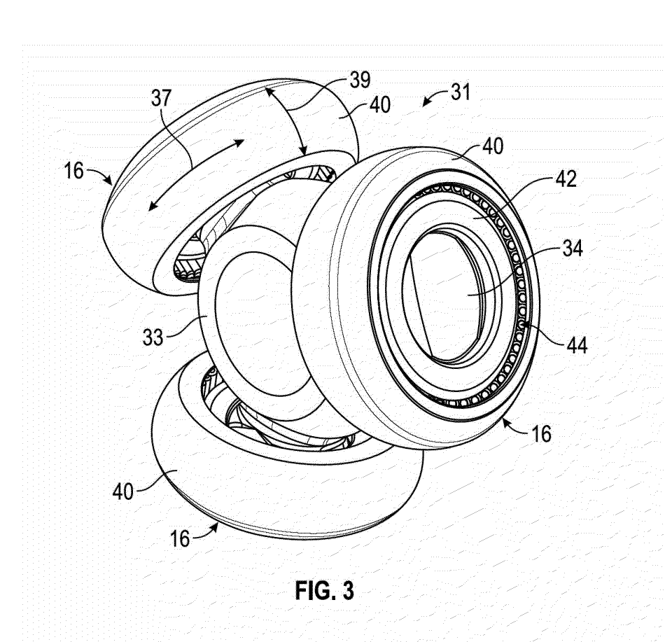

Referring also to FIG. 3, a spider assembly 31 is secured to the distal end portion 15 of the inner drive member 14. The spider assembly 31 includes a spider body 33 having a plurality of trunnions 34, (in this exemplary form three (3) trunnions 34 equally spaced at substantially 120 degrees from each other), and the drive roller assemblies 16 secured to trunnions 34 as shown, and are rotatable in direction 37 and tiltable in direction 39 on trunnions 34. Each of the drive roller assemblies 16 includes an outer ball 40, an inner ball 42, and a plurality of roller bearings 44 disposed between the outer ball 40 and the inner ball 42.

In operation, the outer balls 40 engage the internal corner surfaces 22, 24 of the longitudinal bores 20 into which the trunnions 34 extend, so that the rollers 40 are constrained to roll there along. Each roller 40 is able to rotate about, move lengthwise of, and tilt relative to the trunnion 34 by which it is carried.

Trunnion Texturing

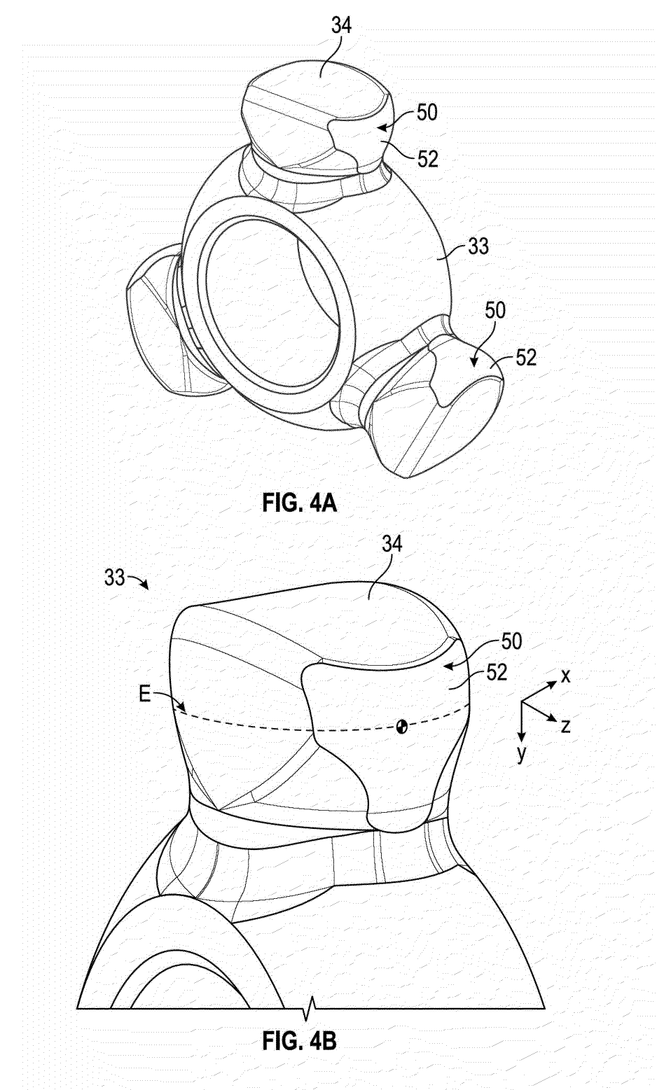

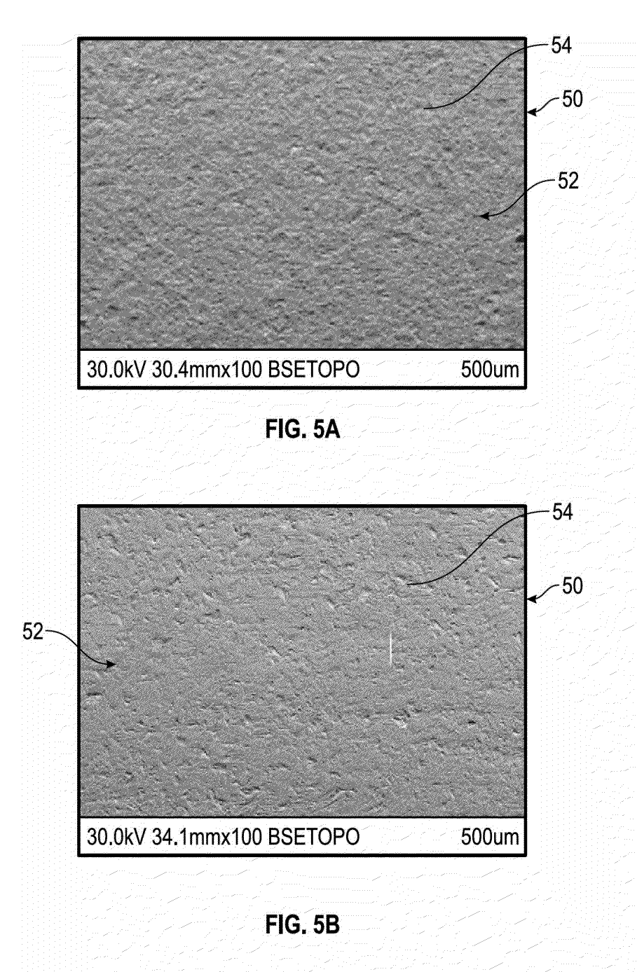

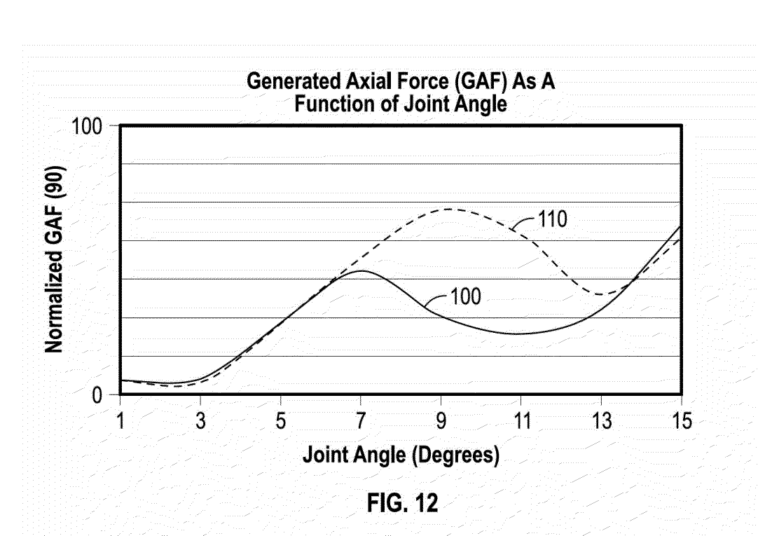

In one form of the present disclosure, a predetermined surface texturing 52 is provided to certain bearing surfaces 50 in order to reduce the “break-in” (also referred to as “running-in”) period, as well as reduce the generated axial forces, of the torque-transmitting joint 10. Referring to FIG. 3 and FIGS. 4A and 4B, each of the trunnions 34 defines bearing surfaces 50, which engage the inner balls 42 of the drive roller assemblies. As further shown in FIGS. 5A and 5B, bearing surfaces 50 of the trunnions 34 define a surface texturing 52 having a random particulate layout of pits 54 having a length/width aspect ratio between about 1:1 and about 5:1, a roughness skewness (Rₛₖ) between about −3.5 and about −0.6, a roughness kurtosis (Rₖᵤ) greater than about 3, and a root mean square roughness (R_{q}) greater than a root mean square roughness (R_{q}) of mating surfaces of the adjacent components. In another form, the root mean square roughness (R_{q}) of the bearing surfaces is greater than and has a magnitude approximately equal to the root mean square roughness (R_{q}) of mating surfaces of the adjacent components. The incorporation of the predetermined surface texturing 52 described above results in a reduction in the generated axial forces (GAF) within the joint, particularly as the joint 10 and inner drive member 14 are articulated to higher joint angles during operation of the joint. FIG. 12 illustrates the difference in GAF as a function of joint angle between a joint 10 where the trunnions include the predetermined surface texture 52 as illustrated by plot 100 as compared to a joint 10 of substantially similar construction that does not have the predetermined surface texture characteristics described herein, particularly those having values of the characteristics outside of the ranges specified herein.

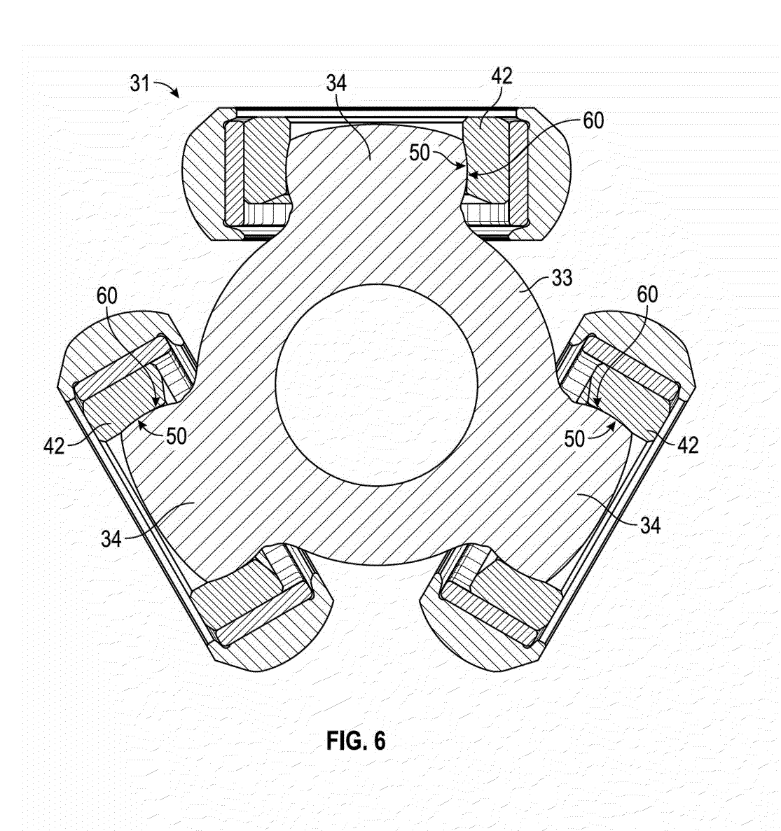

In this illustrative form, the adjacent component is the inner ball 42, which is better shown mating with the bearing surfaces 50 in FIG. 6. In this form, the inner ball 42 is concave with an inner race 60, and the bearing surfaces 50 of the trunnions 34 are convex. However, it should be understood that the bearing surfaces 50 may be of any shape, such as by way of example, an elliptoid or hour glass shape, while remaining within the scope of the present disclosure.

Additionally, in another form of the present disclosure, a maximum height of a waviness profile (W_{z}) of the bearing surfaces 50 of the trunnions 34 is greater than a maximum height of a waviness profile (W_{z}) of the mating surfaces of the adjacent component, e.g., the inner surface 60 of the inner ball 42. Still in another form, the maximum height of a waviness profile (W_{z}) of the bearing surfaces 50 of the trunnions 34 is approximately the same magnitude as the maximum height of a waviness profile (W_{z}) of the mating surfaces of the adjacent component, e.g., the inner surface 60 of the inner ball 42.

As further shown in FIG. 4B, each trunnion 34 defines an equator E, which is a closed curve that extends around the periphery of the trunnion 34 as shown, and which extends through the geometric center of the trunnion 34 along the closed curve. In one form of the present disclosure, the waviness profile (W_{z}) of the bearing surfaces 50 of the trunnions 34 is less than about 4.0 microns in a direction parallel to the equator E of the trunnion 34, and in particular, less than about 1.0 microns. In another form, the waviness profile (W_{z}) of the bearing surfaces 50 of the trunnions 34 is less than about 0.8 microns in the direction parallel to the equator E of the trunnion 34. In still another form, the waviness profile (W_{z}) of the bearing surfaces 50 of the trunnions 34 is less than about 4.0 microns in a direction perpendicular to the equator E of the trunnion 34. In another form, the waviness profile (W_{z}) of the bearing surfaces 50 of the trunnions 34 is less than about 3.0 microns in the direction perpendicular to the equator E of the trunnion 34. In still another form, the waviness profile (W_{z}) of the bearing surfaces 50 of the trunnions 34 is less than about 4.0 microns in any direction along the surface of the trunnion 34.

As shown in FIGS. 5A and 5B, the pits 54 of the surface texturing 52 in one form define a wedge shape. As used herein, the term “wedge” shall be construed to mean a geometrical configuration/shape that includes at least two (2) converging side portions. With this surface texturing 52, it is desirable that the spider body 33 is formed from a material that has a hardness less than a hardness of the inner ball 42. For example, the spider body 33 is a material, such as various grades of iron or steel, having a nominal HRC of about 60, and the inner ball 42 is a material having a nominal HRC of about 62.

The bearing surfaces 50 of the trunnions 34 may also be lubricated with a grease comprising particulate solid lubricants, the particulate solid lubricants comprising a dominant solid lubricant having a particle characteristic size “d,” wherein a ratio of a mean peak to valley roughness (R_{z}) of the bearing surfaces to the particle characteristic size d (R_{z}/d) is less than about 1.00. In another form, the ratio R_{z}/d is less than about 0.75.

With the surface texturing as set forth herein, the break-in time and generated axial forces for the torque-transmitting joint are significantly reduced.

As used herein, the surface roughness terms shall be construed to mean:

Roughness skewness (Rₛₖ) is defined as a measure of the average of the first derivative of the surface (the departure of the surface from symmetry) according to the following equation 1:

$${R}_{sk} = \frac{1}{{mnR}_{q}^{3}} {\sum }_{k = 0}^{m - 1} {\sum }_{l = 0}^{n - 1} {( Z ( {x}_{k} , {y}_{l} ) - μ )}^{3} \qquad ( 1 )$$

Where Z is a height of the departure, xₖ is the abscissa coordinate, yₗ is the ordinate coordinate and μ is the mean value of the departure in the sampled distribution.

Roughness kurtosis (Rₖᵤ) is defined as a measure of the sharpness of profile peaks according to the following equation 2:

$${R}_{ku} = \frac{1}{{mnR}_{q}^{4}} {\sum }_{k = 0}^{m - 1} {\sum }_{l = 0}^{n - 1} {( Z ( {x}_{k} , {y}_{l} ) - μ )}^{4} \qquad ( 2 )$$

Root mean square roughness (R_{q}) is defined as is the square root of the sum of the squares of the individual heights and depths from the mean line according to the following equation 3:

$${R}_{q} = {( \frac{1}{mn} {\sum }_{k = 0}^{m - 1} {\sum }_{l = 0}^{n - 1} {( Z ( {x}_{k} , {y}_{l} ) - μ )}^{2} )}^{0.5} \qquad ( 3 )$$

Mean peak to valley roughness (R_{z}) is defined by sampling a section of standard length from the mean line on the roughness chart. The distance between the peaks and valleys of the sampled line is measured in the z direction. Then, the average peak is obtained among 5 tallest peaks (Zₚ), and the average valley between 5 lowest valleys (Zᵥ).

Ball Circle Diameter (BCD)

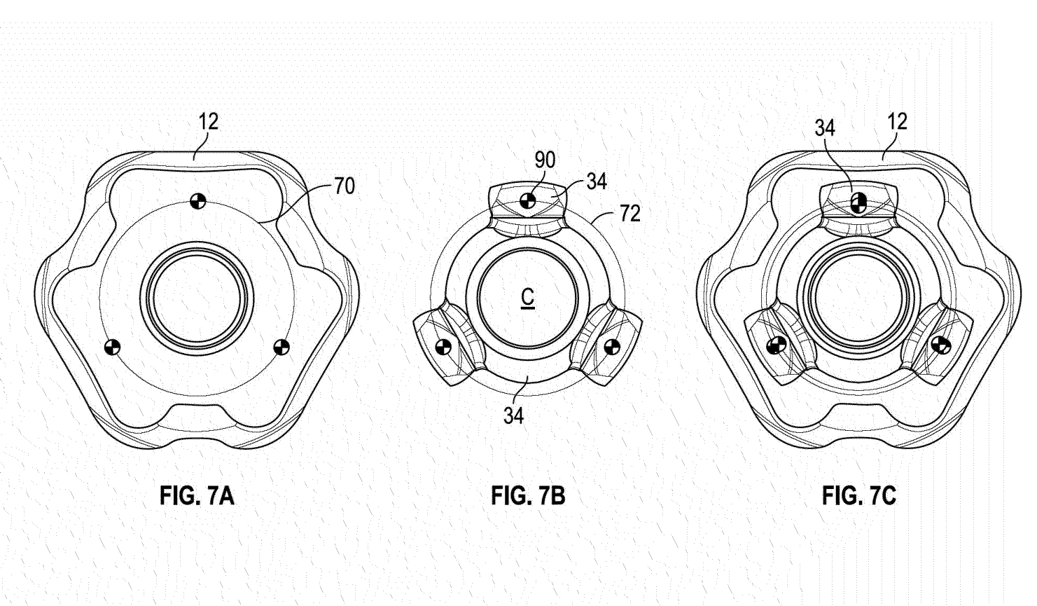

Referring to FIG. 7, another form of the present disclosure is illustrated with the housing 12 defining an internal ball circle diameter (BCD) 70 and a spider assembly 31 (the entire assembly is not illustrated for purposes of clarity) disposed within the housing 12. As previously set forth, the spider assembly 31 comprises a spider body 33 having a plurality of trunnions 34 disposed around an outer profile of the spider body 33, each of the trunnions defining a center C, through which a spider ball circle diameter (BCD) 72 is defined as shown. The spider BCD 72 is nominally more than the housing internal BCD 70 in order to further assist with reducing generated axial force (GAF) across joint angles up to about 15 degrees, and also reducing the break-in time of the torque-transmitting joint 10. In one form, the nominal difference between the spider BCD 72 and the housing internal BCD 70 is between about 0.050 mm and about 0.070 mm.

BCD Tolerancing Scheme

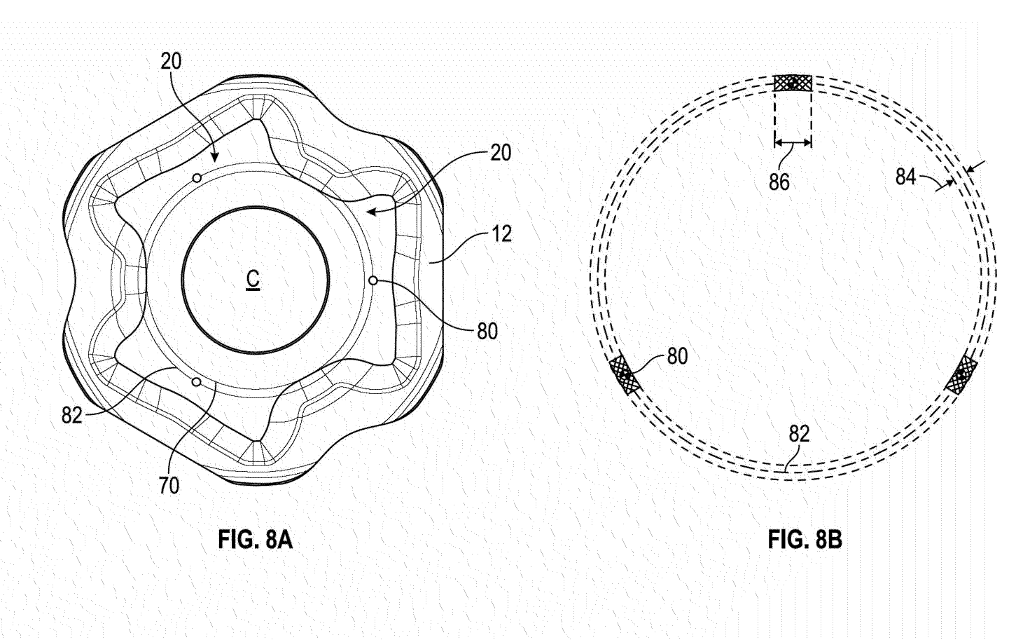

Referring to FIGS. 8A and 8B, a tolerancing scheme is illustrated with reference to the housing 12. As shown in FIG. 8A, the housing 12 includes the plurality of longitudinal bores 20 having a central longitudinal axis (in and out of the page of FIG. 8A), the plurality of longitudinal bores 20 each defining a ball bore center 80 through which passes the bore ball circle diameter (BCD) 82, and the housing 12 defining an internal ball circle diameter (BCD) 70 as previously set forth. As shown in FIG. 8B, a variation of a radial position 84 of the BCDs 70 and 82 to the BCD center C is less than a tangential position variation 86 of the ball bore centers 80, which illustrates and defines “radial variation” 84 and “tangential variation” as those terms are used in the present application

In another form as shown in FIGS. 7A-7C, and also with reference to the tolerancing bands of FIGS. 8A and 8B, the trunnions 34 each define a geometric center 90. The spider body 33 defines a ball circle diameter (BCD) having a center C, (FIG. 7B) and according to another form of the present disclosure, a radial variation of the trunnion geometric centers 90 to the BCD is less than a tangential position variation of BCDs of the housing 12 as previously set forth. Similarly, a radial variation of the housing geometric centers 70 to their BCD is also less than a tangential position variation of the nominal BCD.

Housing Bore and BCD Tolerance

Additionally, similar to the spider body BCD as shown in FIGS. 7A-C and 8A-B, the housing BCD may also define a radial variation of the trunnion geometric centers 90 to the BCD that is less than a tangential position variation of BCDs of the housing 12 as previously set forth.

CMM Program/Method

According to a method of the present disclosure, the dimensional characteristics of a trunnion profile of a spider for use in a torque-transmitting joint are inspected. The method comprises calculating a trunnion center based on a nominal torus geometry, and calculating a ball circle diameter (BCD) of the spider based on the trunnion center.

Polishing Operation

In one form, a polishing operation is performed on the bearing surfaces 50 of the spider body 33, wherein an average roughness (Rₐ) of the bearing surfaces divided by a five-point mean roughness (R_{z}) of the bearing surfaces is between about 0.05 and about 0.19.

Before the bearing surfaces 50 are polished in order to achieve the desired surface texturing, they first undergo a machining and then a blasting operation using an appropriate blasting medium, such as various metal, gall or ceramic beads, before polishing.

Referring back to FIG. 4b, the polishing area extends across and along the entire surface texturing 52. This polishing area extends beyond a band defined by contact of the bearing surfaces 50 of the trunnions 34 with the mating surfaces 60 of the inner ball 42 that would occur during normal articulation and operation of the joint 10 within specified ranges of joint angles. Thus, the joint 10 continues to operate as described herein even if the joint 10 is temporarily placed in an over articulated condition, for example.

Inner Ball Texture

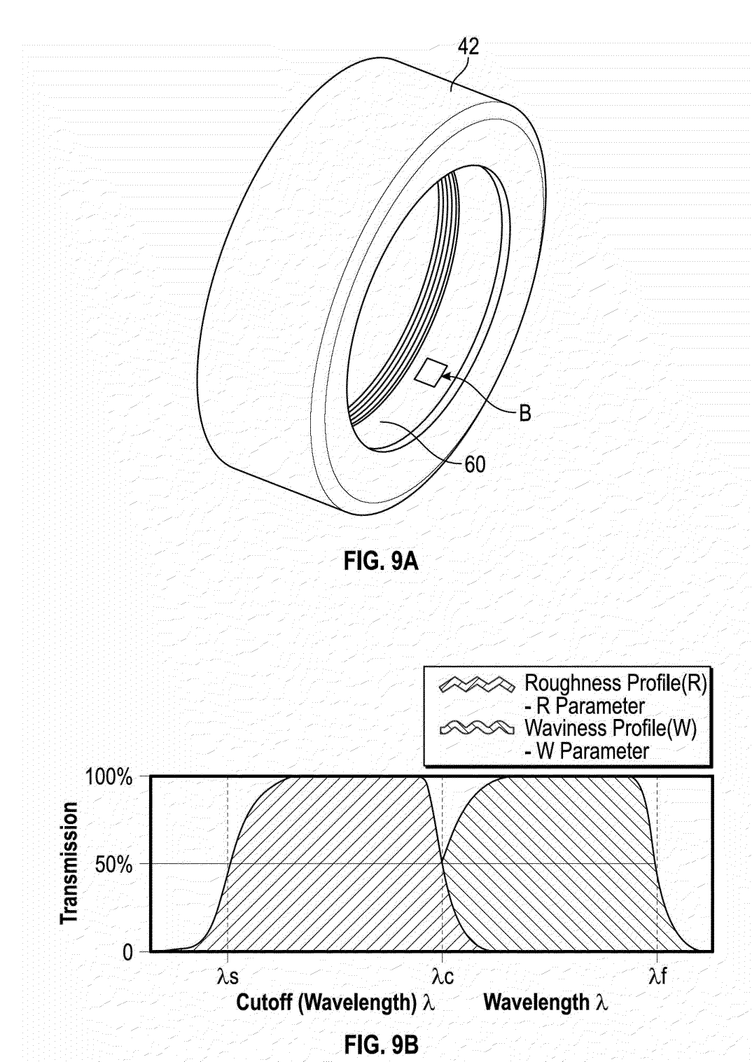

As shown in FIGS. 9A and 9B, another form of the present disclosure is illustrated with an inner ball 42 defining a concave inner surface 60 nominally defined by a roughness profile and a waviness profile, where Rₐ is less than about 0.2, Wₐ is less than about 0.2, and the roughness skewness (Rₛₖ) is less than about 0.

Center Guide Contact

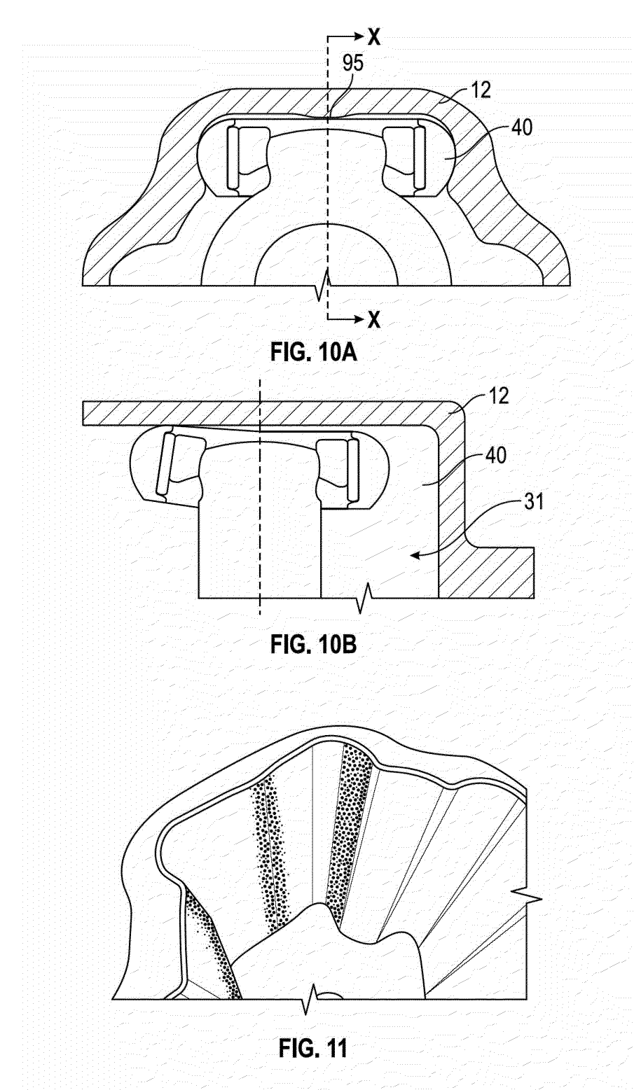

Referring now to FIGS. 10A and 10B and FIG. 11, the spider assembly 31 is shown positioned within the housing 12, highlighting the outer ball 40. The outer ball 40 defines an outer corner profile that contacts the internal surfaces of the housing 12 as shown in FIG. 11, wherein the outer corner profile defines a surface selected from the group consisting of an arc, an ellipse, a B-spline, a plurality of interconnected and intersecting line segments, and combinations thereof, and a minimum dimension of the profile P is about 2 mm. As used herein, the term “minimum dimension” should be construed to mean a dimensional value corresponding to a curvature or B-spline value of the profile, such as by way of example, a radius (arc). It should also be understood that the minimum nominal dimension of about 2 mm is proximate the internal surfaces of the housing 12 along which the outer balls 40 make contact for a 2300 size (N-m nominal torque capacity). In one form, the minimum dimension is about 2.75 for a 2300 size. It should be understood that the minimum dimension may be higher or lower than the 2 mm size used herein for a different size/torque capacity, and thus 2 mm as a lower limit should not be construed as limiting the scope of the present disclosure. In one form, the outer corner profile defines a convex surface having a curvature profile that curves less than a radius of curvature of about 2 mm. In other words, the corner profile defines a convex surface having a curvature profile with a radius of curvature that is greater than about 2 mm, and in another embodiment greater than about 2.75 mm.

When sliding occurs between non-ideal mating surfaces the friction and vibrations generated during the sliding motion are affected by the smallest radii or minimum dimension at the contact. By using a minimum dimension of about 2 mm in the moving part as set forth above, most of the surface imperfections in the static part are mechanically filtered out, reducing friction and dynamic excitations during the roller travel along the longitudinal bores 20 of the housing 12 at the center guide 95. As shown in FIG. 10B, primary contact of the outer ball 40 is at the center guide 95, as indicated by “B.” The left portion of FIG. 10B illustrates a position after a pitching or tilting action of the roller assembly 16, while the right portion of FIG. 10A illustrates a nominal position for comparison. Secondary contact of the outer ball 40 with the housing 12 is then in the corners as indicated by the “A” brackets in FIG. 13a. The contact areas with the internal surfaces of the housing 12 are shown in FIG. 11.

Although the surface texturing, geometrical and dimensional specifications, and methods described herein have been applied to a torque-transmitting joint, it should be understood that other components and types of joints, along with various surface-to-surface bearing applications are contemplated as being within the scope of the present disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An outer ball configured for use in a roller assembly of a torque-transmitting joint, the outer ball defining an outer corner profile that is configured for contact with an internal surface of a housing in which the roller assembly traverses, wherein the outer corner profile defines a convex surface having a curvature profile that curves less than a radius of curvature of about 2 mm.

2. The outer ball according to claim 1, wherein the convex surface comprises an arc, an ellipse, a B-spline, a series of joined line segments, or a combination thereof.

3. The outer ball according to claim 2, wherein a minimum dimension of the curvature profile is about 2 mm.

4. The outer ball according to claim 3, wherein the minimum dimension of the curvature profile is about 2.75 mm.

5. The outer ball according to claim 1, further comprising the torque-transmitting joint comprising:
a housing having a plurality of longitudinal bores defining internal surfaces;
an inner drive member disposed within the housing;
a spider assembly secured to a distal end portion of the inner drive member, wherein the spider assembly comprises:
a spider body defining an outer profile and a central bore, the inner member being secured through the central bore;
a plurality of trunnions disposed around the outer profile of the spider body,
a plurality of roller assemblies secured to the plurality of trunnions, each roller assembly comprising the outer ball, an inner ball, and a plurality of roller bearings disposed between the outer ball and the inner ball.

6. A component of a torque-transmitting joint comprising bearing surfaces having a surface texturing with:
a random particulate layout of pits having a length/width aspect ratio between about 1:1 and about 5:1;
a roughness skewness (Rₛₖ) between about −3.5 and about −0.6;
a roughness kurtosis (Rₖᵤ) greater than about 3; and
a root mean square roughness (R_{q}) having a magnitude equal to a root mean square roughness (R_{q}) of mating surfaces of the adjacent components.

7. The component according to claim 6, wherein the component comprises:
a body defining an outer profile and a central bore;
a plurality of trunnions disposed around the outer profile of the body, each of the plurality of trunnions defining the bearing surfaces that engage adjacent components of corresponding roller assemblies that engage with the plurality of trunnions in operation,
wherein the bearing surfaces of the plurality of trunnions define the surface texturing.

8. The component according to claim 7, wherein the root mean square roughness (R_{q}) of the bearing surfaces has a magnitude approximately equal to the root mean square roughness (R_{q}) of mating surfaces of the adjacent components

9. The component according to claim 7, wherein the bearing surfaces of the trunnions are convex and the mating surfaces of the adjacent component are concave.

10. The component according to claim 9, wherein a maximum height of a waviness profile (W_{z}) of the bearing surfaces of the trunnions is greater than a maximum height of a waviness profile (W_{z}) of the mating surfaces of the adjacent component.

11. The component according to claim 10, wherein the maximum height of the waviness profile (W_{z}) of the bearing surfaces of the trunnions is approximately the same magnitude as the maximum height of a waviness profile (W_{z}) of the mating surfaces of the adjacent component

12. The component according to claim 7, wherein a waviness profile (W_{z}) of the bearing surfaces of the trunnions is less than about 4.0 microns in a direction parallel to an equator of the trunnion.

13. The component according to claim 7, wherein a waviness profile (W_{z}) of the bearing surfaces of the trunnions is less than about 1.0 microns in a direction parallel to an equator of the trunnion.

14. The component according to claim 7, wherein a waviness profile (W_{z}) of the bearing surfaces of the trunnions is less than about 0.8 microns in a direction parallel to the equator of the trunnion.

15. The component according to claim 7, wherein a waviness profile (W_{z}) of the bearing surfaces of the trunnions is less than about 4.0 microns in a direction perpendicular to an equator of the trunnion.

16. The component according to claim 7, wherein a waviness profile (W_{z}) of the bearing surfaces of the trunnions is less than about 4.0 microns in any direction along the trunnion.

17. The component according to claim 14, wherein a waviness profile (W_{z}) of the bearing surfaces of the trunnions is less than about 3.0 microns in the direction perpendicular to the equator of the trunnion.

18. The component according to claim 7, wherein the pits define a wedge shape.

19. The component according to claim 7, wherein the component has a hardness less than a hardness of the adjacent component.

20. The component according to claim 7, wherein the bearing surfaces are lubricated with a grease comprising particulate solid lubricants, the particulate solid lubricants comprising a dominant solid lubricant having a particle characteristic size “d,” wherein a ratio of a mean peak to valley roughness (R_{z}) of the bearing surfaces to the particle characteristic size d (R_{z}/d) is less than about 1.00.

21. The component according to claim 20, wherein the ratio R_{z}/d is less than about 0.75.

22. The component according to claim 7, further comprising the torque-transmitting joint comprising:
a housing;
an inner drive member disposed within the housing;
a spider assembly secured to a distal end portion of the inner drive member, wherein the spider assembly comprises:
the body;
the plurality of trunnions, and
the plurality of roller assemblies secured to the plurality of trunnions, each roller assembly comprising an outer ball, an inner ball, and a plurality of roller bearings disposed between the outer ball and the inner ball.

23. The component according to claim 22, wherein the inner ball comprises a concave inner surface nominally defined by a roughness profile and a waviness profile, where Rₐ is less than about 0.2, Wₐ is less than about 0.2, and the roughness skewness (Rₛₖ) is less than about 0.

24. A torque-transmitting joint comprising:
a housing defining an internal Ball Circle Diameter (BCD); and
a spider assembly disposed within the housing, the spider assembly comprising a spider body having a plurality of trunnions disposed around an outer profile of the spider body, each of the trunnions defining a center, through which a spider Ball Circle Diameter (BCD) is defined,
wherein the spider BCD is greater than the housing internal BCD.

25. The torque-transmitting joint according to claim 24, wherein a difference between the spider BCD and the housing internal BCD is between about 0.050 mm and about 0.070 mm.

26. The torque-transmitting joint according to claim 24, wherein the housing comprises:
a plurality of longitudinal bores and a central longitudinal axis, the plurality of longitudinal bores each defining a ball bore center through which passes a bore Ball Circle Diameter (BCD), and the housing internal Ball Circle Diameter (BCD) having a BCD center,
wherein a radial position variation of the BCDs to the BCD center is less than a tangential position variation of the ball bore BCDs.

27. The torque-transmitting joint according to claim 24, wherein a radial variation of the trunnion geometric centers to the BCD center is less than an angular position variation of the trunnion geometric centers at the BCD.

28. The torque-transmitting joint according to claim 24, wherein the spider is inspected by a method of inspecting dimensional characteristics of the trunnion outer profile, comprising:
calculating a trunnion center based on a nominal torus geometry; and
calculating a Ball Circle Diameter (BCD) of the spider based on the trunnion center.

29. The torque-transmitting joint according to claim 24, wherein a method of fabricating the spider comprises performing a polishing operation on the bearing surfaces of the spider, wherein an average roughness (Rₐ) of the bearing surfaces divided by a five-point mean roughness (R_{z}) of the bearing surfaces is between about 0.05 and about 0.19.

30. The method according to claim 29, further comprising the steps of machining and blasting before performing the polishing operation.

31. The method according to claim 29, wherein the polishing operation defines a polished area of the bearing surfaces that extends beyond an operating area of the bearing surfaces that would engage adjacent components during normal operation of the torque-transmitting joint.
